(19) United States
(12) Patent Application Publication
(10) Pub. No.: US 2020/0157294 A1
(43) Pub. Date: May 21, 2020

(54) STABLE WATER-BASED POLYMER EMULSIONS AND FIBER MODIFICATIONS FOR ENHANCED FIBER WETTING AND IMPREGNATION BASED ON CB[8] GUEST-HOST TECHNOLOGY

(71) Applicant: SABIC Global Technologies B.V., Bergen op Zoom (NL)

(72) Inventor: Bart Vandormael, Bergen op Zoom (NL)

(21) Appl. No.: 16/630,515

(22) PCT Filed: Jul. 13, 2018
(86) PCT No.: PCT/IB2018/055216

§ 371 Date: Jan. 13, 2020

Related U.S. Application Data
(60) Provisional application No. 62/532,506, filed on Jul. 14, 2017.

(51) Int. Cl. C08J 5/10; C08J 5/06

(52) U.S. Cl. CPC C08J 5/10; C08J 5/06; C08J 2323/12; C08J 2381/04; C08J 2369/00; C08J 2379/08; C08J 2377/00

(57) ABSTRACT

Disclosed is a stable, water-based polymer (or oligomer) emulsion that may be combined with a functionalized reinforcement fiber for fiber wetting and impregnation-based composite production. The water-based polymer emulsions are produced using guest-host molecular technology and combined with functionalized fiber reinforcement filler to form a fiber-reinforced thermoplastic composite. The polymer resin, surfactant, and fiber reinforcement may be tailored or customized to facilitate interaction with a guest-host complexation agent.

### TECHNICAL FIELD

This disclosure pertains generally, but not by way of limitation, to composite materials. More specifically, the present disclosure is related to polymer resin-based emulsions for fiber impregnation and prepreg production purposes and methods for the production of the composite materials including polymer resin-based emulsions.

### BACKGROUND

Fiber-reinforced thermoplastic composites (FRTCs) may be used to manufacture articles in various industries and represent a developing class of advanced manufacturing materials. FRTCs have garnered the interest of manufacturers because they are lighter-weight alternatives to traditional manufacturing materials, like metals, while having comparable mechanical properties. An FRTC may include reinforcing fibers that are continuous fibers. FRTCs may have a high strength and stiffness and are commonly produced using constructs or stacks-based continuous fiber-reinforced intermediates (Uni-Directional (UD), textiles, wovens and mats) due to their high alignment and volume fraction of the fiber reinforce used. Continuous fiber prepregs (pre-impregnated composite fibers) may be produced by a number of impregnation methods including hot melt, solution, polymer emulsion, slurry, surface polymerization, fiber comingling, film interleaving, electroplating, and dry powder techniques. Conventional methods for preparing FRTCs are complex and expensive, however.

These and other shortcomings are addressed by aspects of the present disclosure.

### SUMMARY

The present disclosure relates to a method of forming a fiber-reinforced thermoplastic composite by combining a polymer emulsion and modified fiber reinforcement with a guest-host complexation agent. A method for forming a composite may include combining a thermoplastic polymer and a surfactant in the presence of a guest-host complexation agent to form a guest-host polymer emulsion. A fiber reinforcement filler may be modified to form a modified fiber reinforcement filler that may then be combined with the guest-host polymer emulsion.

In further aspects, the present disclosure relates to a fiber-reinforced thermoplastic composite formed by a process comprising: combining a thermoplastic polymer and a surfactant in the presence of a cucurbit[8]uril (CB[8]) to provide a CB[8]-based polymer emulsion. Functionalized reinforcement fibers may be impregnated with the CB[8]-based polymer emulsion to displace the surfactant to form the fiber-reinforced thermoplastic composite.

### BRIEF DESCRIPTION OF THE FIGURES

In the figures, which are not necessarily drawn to scale, like numerals may describe similar components in different views. Like numerals having different letter suffixes may represent different instances of similar components. The drawings illustrate generally, by way of example, but not by way of limitation, various examples discussed in the present document. In the figures:

FIG. 1 presents a selection of pendant moieties showing affinity to the guest-host complexation agent and electron donors.

FIG. 2 presents the cucurbit[8]uril (CB[8]) structure and a selection of guest moieties based upon hydrophobicity and/or hydrophilicity.

FIG. 3A presents a selection of pendant moieties having affinity for CB[8].

FIG. 3B presents a graphical representation of binding constant (Kₐ) values for CB[8]MBBI-ternary complexes and CB[8]MV-ternary complexes.

FIGS. 4A and 4B present a selection of pendant moieties having affinity for CB[8].

FIG. 5A presents a diagram for functionalization of epoxy-sized reinforcement fiber.

FIG. 5B presents a diagram for functionalization of unsized reinforcement fiber by a grafting process.

FIG. 6 presents a schematic diagram for the formation of CB[8]-based polymer emulsion impregnation and composite production.

FIG. 7 presents a scheme for reaction kinetics governing the use of CB[8]-based polymer emulsions for impregnation and composite production.

### DETAILED DESCRIPTION

Manufacturing materials that minimize weight while maximizing mechanical performance are highly desired across industries. Components based on Fiber Reinforced Thermoplastic Composites (FRTC) may achieve this goal. FRTCs generally include two main components: 1) the reinforcing fibers; and 2) the thermoplastic matrix. The alignment of fibers and the fiber volume fraction within the composite structure may determine the composite's overall mechanical properties (tensile strength, stiffness, impact). The thermoplastic matrix contributes to the thermal properties and is a major factor for the force distribution among the reinforcing fibers. Typical thermoplastic matrices used in composites include, but are not limited to, polypropylene (PP), polyamide 6 (PA6), polyamide 66 (PA66), polybutylene terephthalate (PBT), polycarbonate (PC), polyetherimide (PEI), and polyether ketone (PEEK). FRTCs that exhibit both high strength and stiffness are commonly produced using constructs or stack-based continuous fiber-reinforced intermediates due to the high alignment and volume fraction of the fiber reinforcement used. The present disclosure provides an efficient method of forming the composite by guest-host technology-based polymer emulsion impregnation and composite production.

Within the composite manufacturing industry, injection molding and sheet molding compound (SMC) are widely used in fabricating structural components because of their excellent formability and relatively low cost. However, the fibers are distributed randomly in the composites and the fiber volume fraction (equal to or less than 40%) is much lower than that (about 60%) of continuous fiber-reinforced plastics due to the limitation of these two fabrication methods. The random distribution of fibers and relatively low fiber volume fraction lead to low stiffness and strength compared to conventional FRTCs, which have continuous fibers and nearly 60% fiber volume fraction. These shortages limit the application of traditional short fiber-reinforced composites in some structural components. As a result, FRTCs with continuous fibers and a higher fiber volume fraction are commonly used in the form of Uni-Directional (UD), textiles, wovens and mats to produce structural components. FRTCs may be produced by compression molding by stacking multiple components into a sandwich structure. Another production methodology includes the use of specific laminate constructs based on UD-tapes which have been pre-consolidated in a double belt press. These laminates are then preheated, formed and subsequently over-molded. Continuous fiber prepregs of the FRTCs are conventionally produced by a number of impregnation methods including hot melt, solution coating, slurry coating, surface polymerization, fiber comingling, film interleaving, electroplating, dry powder techniques, and polymer emulsion. These preparation methods have a number of disadvantages, however.

In hot melt processing, impregnation can be accomplished by forcing the fiber and resin through a die at high temperature under conditions that create high shear rates. This process completely encapsulates essentially all the fibers, which may cause the prepreg to be very stiff and brittle. Other disadvantages of this process include the high stress applied to the fibers and difficulties in impregnating the fiber, leading to low processing speeds.

In solution coating, a matrix thermoplastic material is dissolved in solvent to provide a solution, and the fiber reinforcement is passed through this solution and then dried to evaporate the solvent. Two disadvantages of this process are that thermoplastics usually exhibit limited solubility at high concentration, and most engineering thermoplastics cannot be dissolved in a low boiling solvent at room temperature. Additionally, high solution viscosity may result in the same impregnation problems as with hot melt, and may cause the fibers to stick together. Another problem is the difficulty in removing the solvent; traces of solvent left in the prepreg lead to undesirable porosity in the composite structures.

Slurry coating, or wet powder processing, is a non-solvent coating technique designed to resolve the problem of insolubility of the thermoplastic in solvent at room temperature. In slurry coating, the powder is suspended in a liquid medium, wherein no solvency exists between the resin and the medium, and the fibers are drawn through the slurry. The slurried particulate matrix does not substantially wet-out the fiber, resulting in the need for higher pressures to consolidate the matrix and fibers into a prepreg. In addition, this prepreg can be tacky, which is not suitable for weaving or braiding. Other disadvantages include the necessity for the removal of the liquid medium, volatiles, and dispersants or surfactants which are used to form the polymer/liquid colloidal state, the likelihood of aggregates in the slurry caused by poor mixing, and the possibility that polymer particles will settle during processing.

An emulsion process may be used to apply a particulate polymer matrix material with a very small particle size to prepreg fibers by synthesizing the resin as an aqueous emulsion with a surfactant. Generally, the polymer emulsion may be produced by: 1) high shear/high speed mixing of a polymer solution with an aqueous solution of surfactants; or 2) mixing the polymer and water in a hydrothermal pressurized process. To achieve intimate mixing in emulsion or slurry coating, the particulate size of the slurry or emulsion should be smaller than the fiber diameter. However, some thermoplastics cannot be made via emulsion or dispersion polymerization processes; these thermoplastics may include polycarbonate, polyester, polyamide, polyphenyl sulphide, polyimides and polyaryl ether ketones. Generally, polymers based on styrenic, acrylate monomers may be produced via radical polymerization by means of emulsions or dispersions. For many of the thermoplastics that cannot be made by emulsion or dispersion polymerization, it is extremely difficult to produce such fine powder. Thus, a coarse blend between fibers and particles is obtained. Unfortunately, the quality of the blend decreases as the particle size increases, leading to poor matrix distribution in the consolidated prepreg and thus a poor composite structure. Furthermore in the conventional polymer emulsion process, the removal of the surfactant from the final prepreg is difficult.

The present disclosure addresses the shortcomings of conventional processes by describing a stable, water-based polymer (or oligomer) emulsion by guest-host technology that may be combined with a functionalized reinforcement fiber for fiber wetting and impregnation-based composite production. In various aspects, water-based polymer emulsions disclosed herein are produced using guest-host molecular technology and combined with functionalized fiber reinforcement filler to form a fiber-reinforced thermoplastic composite. The polymer emulsion may include a thermoplastic polymer resin (or oligomer resin) and a surfactant. The polymer resin and surfactant may be tailored or customized to facilitate interaction with a guest-host complexation agent. The polymer resin may include certain pendant moieties (guest moieties) that exhibit affinity for the guest-host complexation agent while the surfactant may be tailored according to its hydrophilic and/or hydrophobic character in addition to certain pendant moieties. In forming the composite material, a displacement mechanism may occur between the surfactant and functionalized moieties of the reinforcement fiber which results in bonding between the polymer and the reinforcement fiber.

In aspects of the present disclosure, a guest-host complexation polymer emulsion may be prepared by combining a thermoplastic polymer (or oligomer) resin and a surfactant in the presence of a guest-host complexation agent. The combined guest-host complexation agent and polymer emulsion may be reacted with functionalized reinforcement fibers for impregnation for composite production. The reinforcement fibers may be functionalized with moieties that exhibit higher affinity for the guest-host complexation agent (such as, for example, methyl viologen). The moieties may displace and/or dissociate the hydrophilic moieties of the surfactant within the particles of the polymer emulsion. As a result, the polymer emulsion may bond uniformly onto the functionalized fibers and may thereby release and/or remove the hydrophilic surfactant upon drying and/or application of a vacuum. According to aspects of the present disclosure, guest-host interactions between functionalized fiber/polymer matrix and polymer matrix/polymer matrix within a composite may enhance the composite's interfacial shear strength, interlaminar shear strength and formability due to its thermal reversible properties. The disclosed methods are not limited to a specific type of fiber system such as UD tapes, but may apply to all fiber systems (woven, non-woven, mats, and textiles) that may require impregnation of polymers on to it by emulsions.

As provided above, a guest-host complexation polymer emulsion may be prepared by combining a thermoplastic polymer (or oligomer) resin and a surfactant in the presence of a guest-host complexation agent. Guest-host technology focuses on the direct association of guest-host pairs, which involves host macrocycles such as cyclodextrins and cucurbit[n]urils (CB[n]) and a wide range of guest molecules. Association to form a complex is typically driven by molecule size and hydrophobicity. The association of the macrocycle and guest molecules forms ternary complexes which may dissociate at elevated temperatures, thereby facilitating the flowability and formability. Upon cooling, these ternary complexes may be reinstated, providing the polymer with enhanced mechanical performance and interlaminar shear strength. The present disclosure applies guest-host interactions in aspects of polymeric material assembly. Specifically, cucurbit[n]uril may be used to stabilize a polymer (or oligomer) emulsion in reaction with functionalized reinforcement fibers for composite preparation by impregnation.

Cucurbit[n]urils (CB[n]) are macrocyclic molecules made of glycoluril (═C₄H₂N₄O₂═) monomers linked by methylene bridges (—CH₂—). The oxygen atoms are located along the edges of the band and are tilted inwards to form a partly enclosed cavity, (to house a host). Cucurbiturils are commonly denoted as cucurbit[n]uril, or CB[n], where n refers to the number of glycoluril units. Cucurbit[n]urils may be suitable hosts for an array of neutral and cationic species. Binding may occur through hydrophobic interactions, and, for cationic guests species, may occur through cation-dipole interactions as well. The disclosed CB[n]-based polymer emulsions for fiber impregnation and composite production disclosed herein may include a multifunctional CB[8] work horse (having 8 glycoluril units) as shown in formula (I).

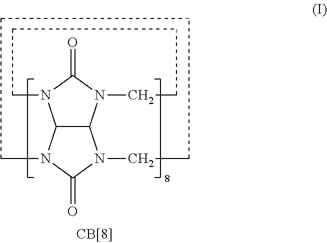

CB[8] host-guest technology has been known to stabilize colloid emulsions and form ternary complexes in water or solvents. CB[8] ternary complexes may be inhibited by analytes with strong affinity, due to improved (de)solvation effects. Various combinations of ligands within CB[8] have been reported along with their binding constants and other thermodynamic properties. The present disclosure uses guest-host technology, combined with the selection of specific ligands for the polymer, surfactant, and fiber reinforcement in fiber impregnation and composite manufacturing.

CB[8] may engage with two specific ligands in an aqueous solution to form a ternary complex. The stability of such a ternary complex may be determined by the compatibility of the ligands within the CB[8] molecule. Complex stability may be driven by lowering Gibbs free energy of the thermodynamic system by removing the “high energetic water” from the cavity by (de)solvation effects. The formation of such CB[8]-based ternary complexes may be tuned by selecting the appropriate ligands or moieties that have high binding constants. Furthermore, this enables design of a strategy to add another ligand that can dissociate/displace an existing ternary complex (for example, CB[8]-Ligand1-Ligand2) due its higher affinity into a more stable ternary CB[8]-based complex. Pendant moieties or ligands may be tailored at the thermoplastic polymer, the surfactant, and at the fiber reinforcement.

In aspects of the present disclosure, designing a strategy for ligand addition may require a consideration of the formation of the complexes. Generally, a first binary complex may be formed by the CB[8] guest host molecule and a pendant moiety that exhibits a good affinity for the CB[8] molecule. The association constant for the formation of the binary complex may be described as Kₐ₁. Stability of the binary complex may depend upon the energy state or equilibrium conditions for the binary complex itself. The generated binary complex may then form a first ternary complex with a second pendant moiety. Stability of the first ternary complex may depend upon the affinity of the second pendant moiety with the binary complex. Where the second pendant moiety exhibits a similar binding affinity to the CB[8] molecule as the pedant moiety of the binary complex, a stable ternary complex may be sustained. Where the second pendant moiety however exhibits a higher affinity to the CB[8] molecule, the second pendant moiety may displace the first pendant moiety.

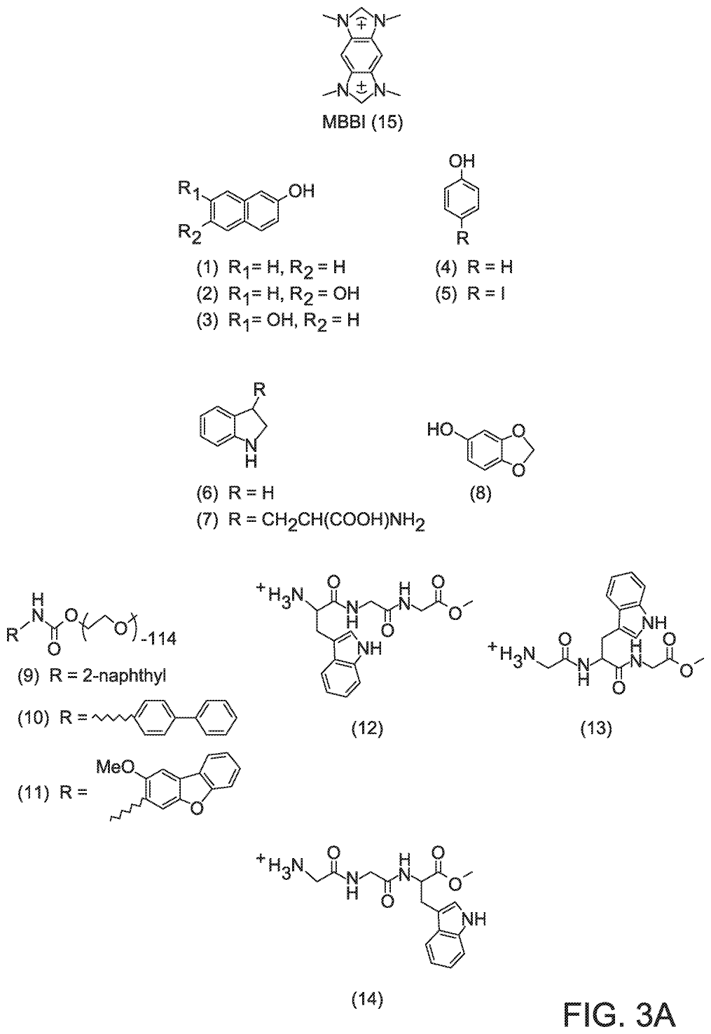

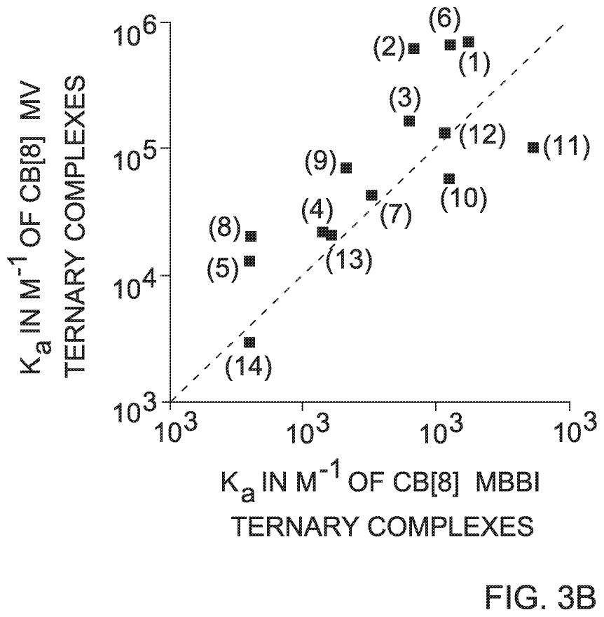

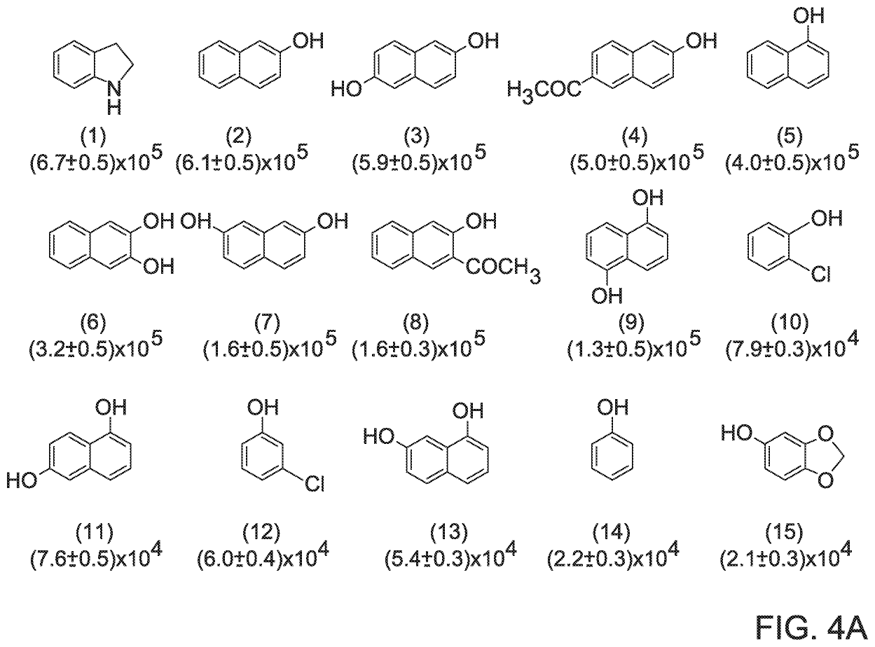

For example, a binary complex may form between the CB[8] molecule and a surfactant molecule having pendant moieties that exhibit good affinity to the CB[8]. The formation may be designated association constant Kₐ₁. A thermoplastic polymer having pendant moieties that exhibit superior affinity may then form a ternary complex with the CB[8]-surfactant binary complex. The formation may be designated association constant Kₐ₂. The pendant moieties of the thermoplastic polymer may include moieties presented in FIGS. 4A and 4B, and specifically moieties 1-3 and 6 of FIG. 3B described in further detail below. FIGS. 3A, 3B, 4A and 4B are adapted from Nau and Scherman, “Cucurbiturils,” Isr. J. Chem. 2011, 51, 537-550. In one example, the thermoplastic polymer pendant moieties may include 2,6 naphthyl. A functionalized fiber having pendant moieties exhibiting a “high affinity” for complexing with CB[8] may displace the “good affinity” pendant moieties of the surfactant moiety to form the more stable ternary complex including CB[8] and the pendant moieties of the thermoplastic polymer and functionalized fiber. The formation may be designated association constant Kₐ₃.

As used herein, the relative terms “high affinity,” “good affinity,” and “low/poor affinity” may be defined according to values for the binding constant Kₐ of the complexes. Affinity may be quantified by means of the binding constant of the respective studied complexes using Isothermal Titration calorimetry (ITC) (J. Am. Chem. Soc. 2013, 135, 14879-14888). A high affinity may be defined by a binding constant Kₐ with a value higher than 10⁵ inverse Molar (M⁻¹), while a low or poor affinity may be defined by a Kₐ between 1 M⁻¹ and 10² M⁻¹. A good affinity may be defined as a Kₐ value between 10² M⁻¹ and 10⁵M⁻¹. In aspects of the present disclosure, a pendant moiety having a high affinity for CB[8] may displace a pendant moiety having a good affinity for CB[8].

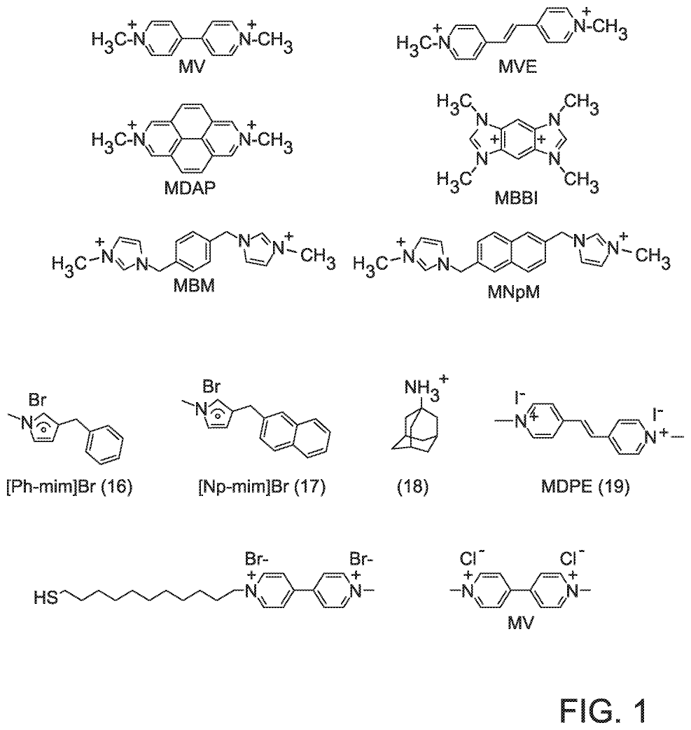

FIG. 1 presents several ligands that may be suitable for CB[8]-based complexes. These ligands may include 4,4′-(1,2-ethenediyl)bis[1-methyl-pyridinium salt (MVE), 2,7-dimethyl-benzo[lmn][3,8]phenanthrolinium salt (MDAP), 1,1′-[1,4-phenylenebis(methylene)] bis[3-methyl-1H-Imidazolium salt (MBM), 3,3′-[2,6-naphthalenediylbis(methylene)]bis[1-methyl-1H-Imidazolium] salt (MNpM), tetramethyl benzobis(imidazolium) salt (MBBI), 1-methyl-3-(phenylmethyl)-1H-Imidazolium bromide ([Ph-mim]Br), and 1-methyl-3-(2-naphthalenylmethyl)-1H-Imidazolium bromide (Np-mim]Br). For example, methyl viologen (MV, 1,1′-dimethyl-4,4′-bipyridinium salt), as shown in FIG. 1, may be useful as a moiety for the functionalized fiber reinforcement that exhibits a “high” affinity to CB[8] and electron donor moieties such as 2,6 naphthyl (2,6-Np). In some aspects of the present disclosure, the 2,6-Np ligand may be a pendant moiety at the thermoplastic polymer. Table 1 presents exemplary thermodynamic data for ternary complexation formation of a CB[8] dicationic auxiliary guest (AG) molecule (the binary complex) with a 2,6-Np ligand as determined by isothermal titration calorimetry. Table 1 is adapted from J. Am. Chem. Soc. 2013, 135, 14879-14888.

TABLE 1
Binding constant and Gibbs free energy for CB[8] ternary complexes.

| Binary | | | | | |
|---|---|---|---|---|---|
| complex | Ligand | Ka | ΔG | ΔH | −TΔS |
| CB[8]-MVE | 2,6-Np | 2700 ± 100 | −36.7 ± 0.3 | −56.8 ± 1.0 | 20.1 ± 1.3 |
| CB[8]-MV | 2,6-Np | 590 ± 20 | −32.9 ± 0.3 | −53.7 ± 1.0 | 20.7 ± 1.3 |
| CB[8]-MDAP | 2,6-Np | 390 ± 20 | −31.9 ± 0.3 | −65.4 ± 1.2 | 33.4 ± 1.5 |
| CB[8]-MBBI | 2,6-Np | 71 ± 9 | −27.7 ± 0.3 | −56.9 ± 1.0 | 29.2 ± 1.3 |
| CB[8]-MNpM | 2,6-Np | 1.2 ± 0.2 | −17.5 ± 0.4 | <0 | NA |
| CB[8]-MBM | 2,6-Np | Binding not | NA | NA | NA |
| | | detected | | | |

MVE represents a methyl viologen derivative known as methyl viologen 1,2-ethenediyl (or 4,4′-(1,2-ethenediyl)bis[1-methyl-pyridinium] salt. The Kₐ₂ describes the association constant for formation of the ternary complex; ΔG is the Gibbs free energy constant in kilojoules per mol (kJ/mol); ΔH is the change in enthalpy in kJ/mol); and −TΔS in kJ/mol provides the temperature T and change in entropy ΔS for calculation of the AG according to the equation ΔG=ΔH−TΔS.

Accordingly, MNpM may be useful as a pendant moiety for the surfactant because MNpM exhibits a “good” affinity to CB[8] and electron donor moieties such as 2,6 naphthyl. The ligands may be considered electron acceptors. The electron acceptors may pair with the electron donors of the pendant moieties of the polymer (or oligomer) resin described herein. Thus, the MNpM moiety may be displaced in the ternary complex by pendant moieties of the functionalized fiber reinforcement that exhibit high affinity to CB[8] and electron donor moieties such as 2,6 naphthyl. As an example, methyl viologen is a high affinity moiety.

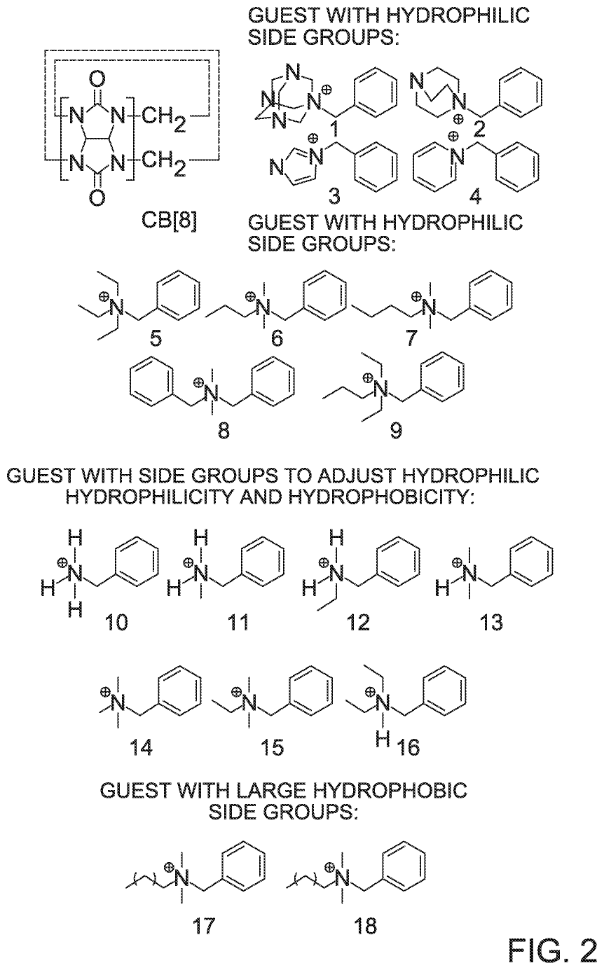

FIG. 2 presents a variety of guest species for CB[8] according to hydrophilicity/hydrophobicity. These guest species may be present in the CB[8] molecule and may affect the formation of binary and ternary complexes with good affinity and high affinity pendant moieties.

Using the theory of guest-host complexation, the present disclosure describes the specific selection of ligands (or pendant moieties) in the polymer emulsion, surfactant, and fiber reinforcement that provide a number of advantages via the CB[8] ternary complex. The ternary CB[8] complex may: stabilize emulsions; bond emulsion particles on the modified fibers; remove surfactants used to prepare the polymer emulsion; improve mechanical performance by creating dynamic links between fiber/matrix in the resulting composite; reduce residual surfactant content (reduced fiber de-bonding); enhance interfacial shear strength; enhance inter-laminar shear strength; improve formability (using thermal reversibility of guest-host ternary complex); improve fiber wetting (low consolidation pressures); and/or improve composite mechanical properties (strength, bending, fatigue). Furthermore, because the impregnation process is water-based, it is environmentally friendly, or “green.” The process also provides flexibility regarding the type of thermoplastic used for the polymer emulsion because a broad variety of thermoplastics are appropriate. In contrast and as described above, in conventional polymer emulsion impregnation methods only certain thermoplastics readily emulsify.

The CB[8] ternary complex in the disclosed polymer emulsion/functionalized fiber system may also provide certain improvements in high performance-discontinuous fiber method (HIPERDIF or HiPerDiF) or discontinuous aligned fiber tape processes. HIPERDIF may refer to a high speed process to produce discontinuous fiber materials architectures with high volume fraction of fiber. For example, there may be an improved and consistent fiber alignment in the converging fluid method. There may be an improved self-sorting and alignment of two different types of functionalized fibers towards each other (glass surrounded with carbon fiber and vice versa) by guest-host technology. There may be a more consistent homogenous distribution of different fiber types within two or tape. Process speed may also be improved, thereby conserving alignment and process stability.

As provided above, an array of thermoplastic polymer resins (or oligomer resins) may be used in forming the polymer emulsion. For example, the thermoplastic may be an oligomer, a low molecular weight linear polymer chain, a high molecular weight polymer chain, or a cyclic polymer resin. The thermoplastic resin may include polypropylene, polyethylene, ethylene-based copolymer, polycarbonate, polyamide, polyester, polyoxymethylene (POM), polybutylene terephthalate (PBT), polyethylene terephthalate (PET), polycyclohexylendimethylene terephthalate (PCT), liquid crystal polymers (LCP), polyphenylene sulfide (PPS), polyphenylene ether (PPE), polyphenylene oxide-polystyrene blends, polystyrene, high impact modified polystyrene, acrylonitrile-butadiene-styrene (ABS) terpolymer, acrylic polymer, polyetherimide (PEI), polyurethane, polyetheretherketone (PEEK), poly ether sulphone (PES), an N-phenyl phenolphthalein bisphenol polycarbonate (PPPBP-PC) copolymer, and combinations thereof. The thermoplastic resin may include thermoplastic elastomers such as polyamide and polyester-based elastomers. The thermoplastic resin may include blends and/or other types of combination of resins described above. Exemplary thermoplastic polymer resins may include, but are not limited to, polypropylene (PP), polyamide 6 (PA6), polyamide 66 (PA66), polybutylene terephthalate (PBT), polycarbonate (PC), polyetherimide (PEI), polyether ketone (PEEK), polyphenylene sulfide (PPS), or a combination thereof.

The thermoplastic polymer or oligomer resin may include certain pendant moieties. The pendant moieties may exhibit an affinity, or high affinity, to form a ternary complex with the guest-host complexation agent, such as CB[n]. In one example, the pendant moieties may exhibit high affinity with CB[8]. More specifically, the pendant moiety may have a high affinity to form a ternary complex with methyl viologen CB[8] (MV-CB[8]). Exemplary pendant moieties may include 2-naphthol and phenol; several of which are presented in FIG. 3A. The structural formula for pendant moiety tetramethyl benzobis(imidazolium) (MBBI) is also shown. FIG. 3B provides a graphical representation of binding constant (Kₐ) values for CB[8]-MBBI-ternary complexes and MV-CB[8]-ternary complexes with the selection of pendant moieties presented in FIG. 3A. As shown, pendant moieties 2, 6, and 1 show a high affinity for forming a ternary complex. FIG. 4 provides an additional scheme of pendant moieties that may be present within the polymer (or oligomer) resin that exhibit affinity to form a ternary complex with MV-CB[8]. The pendant moieties may be considered electron donors.

As provided above, the thermoplastic resin may be combined with a surfactant in the presence of cucurbit[8]uril (CB[8]). The surfactant may include a hydrophilic moiety and a pendant moiety (which shows good affinity to CB[8]), linked by an organic linker. The hydrophilic moiety of the surfactant may include, for example, ethylene glycol ethers and ethoxylates. Exemplary pendant moieties, as described above, may include 2-napthol, phenol, napthyl-bisimidazolium salt, and biphenyl-bisimadazolium salt. The organic linker of the surfactant may comprise a polar nanoparticle or an organic molecule or such as an aliphatic or aromatic constituent. An exemplary surfactant linker may include ethylene glycol or other ether constituents.

The formulation of the thermoplastic (polymer or oligomer) emulsion used in the impregnation of fibers may affect the final properties of the composite part. The fiber/matrix interphase may affect the interfacial shear strength and inter laminar shear strength and the mechanical properties (for example, tensile strength, bending strength, impact and fatigue) of a fiber-reinforced composite part. Due to fiber/matrix interphase modifications or adequate fiber sizing/matrix selections, it is generally believed that this may lead to improved stress transfer or dissipation of the fiber toward the matrix and total composite structure.

Desirably, the polymer emulsion for use with the guest-host complexation agent may have certain properties. The polymer emulsion may have a low viscosity. The polymer emulsion may also be stable at a relatively high solid content, for example, a solid content greater than 30%. Stability may be indicated where there is no change or minimal change in particle size/particle size distribution (PS/PSD) for at least 6 months. The polymer emulsion may also have a monomodal particle size distribution which may be critical for good storage stability and better packing efficiency upon fiber wetting and impregnation. The polymer emulsion may have a low particle size (i.e., a PS less than 180 nanometers (nm)). A desirable polymer emulsion may provide a 100% process yield and may be free of, or substantially free of, a chemical solvent in formulation. The lack of a chemical solvent may ensure a low volatile organic compound (VOC) content, non-flammability, non-toxicity, and an odorless solution.

In specific examples, the polymer emulsion may have an average particle size from about 40 nanometer (nm) to about 1000 nm, but preferably smaller than 400 nm. The polymer emulsion may have a narrow particle size volume distribution that is within a range calculated via formula (II).

Particle size distribution=(D₉₀−D₁₀)/D₅₀ (II)

where D represents the diameter of particles, D₅₀ is a cumulative 50% point of diameter (or 50% pass particle or the value of the particle diameter at 50% in the cumulative distribution); D₁₀ means a cumulative 10% point of diameter; and D₉₀ is a cumulative 90% point of diameter; D₅₀ is also called average particle size or median diameter.

More specifically, the polymer emulsion may have a unimodal distribution. In some aspects, the polymer emulsion may be stable enough so that it may be stored for at least 3 months, at least 6 months, or about 9 months at room temperature without deviation from the ranges for average particle size and average particle size distribution. The polymer emulsion may have a solid content greater than 30% and low shear viscosity, for example, about 1 to about 1.5 centiPoise (cP) at 25° C. In further examples, the polymer emulsion may be Registration, Evaluation, Authorization and Restriction of Chemicals (REACH)-compliant.

The polymer emulsion may be formed from a number of methods. As an example, the polymer emulsion may be formed by dissolving a suitable thermoplastic polymer in a solvent such as dichloromethane, acetone, or hexane. The dissolved polymer and CB[8] may be combined in a water solution containing the surfactant and mixed using high speed mixing. In other examples, the emulsion may be formed by high speed mixing of the dissolved thermoplastic into a (water-based) solution including the surfactant and CB[8].

High shear mixers and high pressure hydrothermal homogenizers are two processes that may be used to achieve the ternary complex for the functionalized polymer with specific pendant endgroups. The high shear mixer process may include three steps (functionalization, homogenization, and solvent evaporation). As an example, an appropriate thermoplastic polymer (such as, for example, polypropylene-maleic anhydride, a low molecular weight polycarbonate, a polycarbonate polysiloxane copolymer, a polyetherimide, a low molecular weight polybutylene terephthalate, a phenolphthalein phenyl phthalimide bisphenol polycarbonate (PPPBP-PC) copolymer) may be dissolved and combined with a reagent to functionalize the polymer. The resulting mixture may be added to an aqueous surfactant solution and homogenized or mixed. The solvent may be removed and stirred to provide (depending upon the starting thermoplastic polymer).

On the other hand, the high pressure hydrothermal homogenizer is a single step process which may be achieved at a lab scale. an appropriate thermoplastic polymer (such as, for example, polypropylene-maleic anhydride, low molecular weight polycarbonate, the polycarbonate polysiloxane copolymer, polyetherimide, low molecular weight polybutylene terephthalate) may be reacted with an aqueous 2-naphtol base and MNpM-linker-polyethylene glycol and CB[8] to provide a naphthyl functionalized thermoplastic emulsion, For a phenolphthalein phenyl phthalimide bisphenol polycarbonate, the thermoplastic may be reacted with the MNpM-linker-polyethylene glycol and CB[8] to provide a naphthyl functionalized phenolphthalein phenyl phthalimide bisphenol polycarbonate.

The methods of the present disclosure and composites formed therefrom use dynamic bonding methodologies to improve conventional impregnation formation of composite materials. To improve the stress transfer, interphases have been developed that have an intermediate modulus between the fiber and matrix (crosslinking, gradient, fillers at interface). Covalent bonding (fiber surface functionalization by grafting, plasma treatment, coating), physical bonding (enhanced fiber/matrix friction), and mechanical bonding (enhance fiber surface roughness) have been used to improve the compatibility between the reinforcement fiber and the thermoplastic matrix.

As provided above, reinforcement fibers may be modified with functional groups/ligand/pendant moieties that may form ternary complexes with a CB[n] guest-host complexation agent such as CB[8]. A number of functional moieties as described above may be desirable. For example, the reinforcement fiber may be functionalized with an electron donor moiety such as methyl viologen. Exemplary fibers that may be functionalized include, but are not limited to, glass fibers, carbon fibers, nanotubes, aramid fibers, and basalt fibers.

The reinforcement fibers for functionalization may be sized or unsized. The sized or unsized fibers may be modified to include a functional moiety that may form a ternary complex within the CB[8] with a “high” affinity so as to displace the surfactant moiety. Sized fibers are coated on their surfaces with a sizing composition selected for compatibility with a given thermoplastic polymer. A sizing composition may facilitate wet-out and wet-through of the thermoplastic upon the fiber strands and assists in attaining desired physical properties in the thermoplastic.

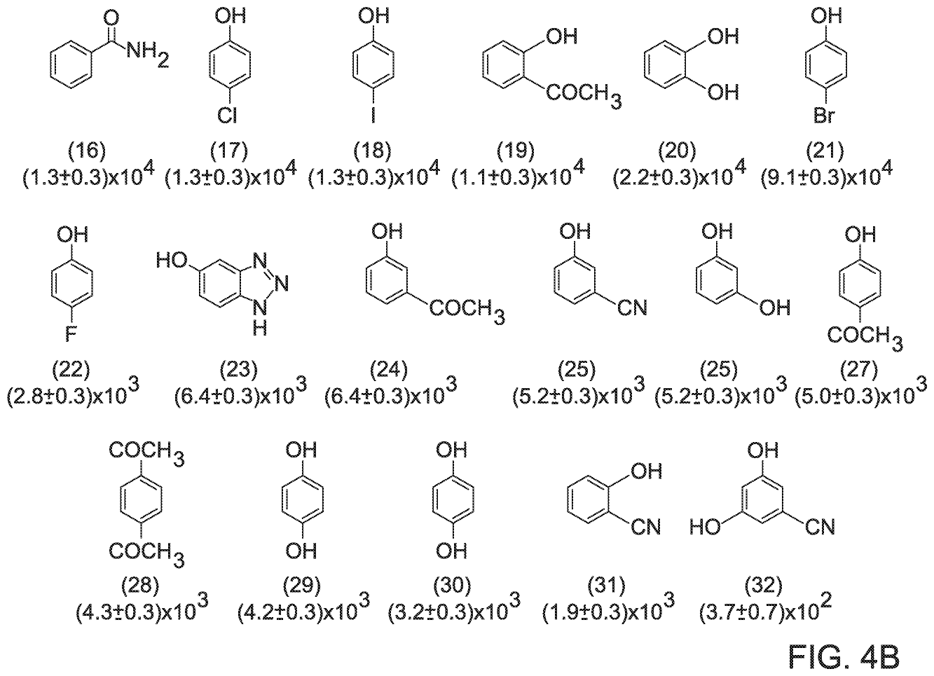

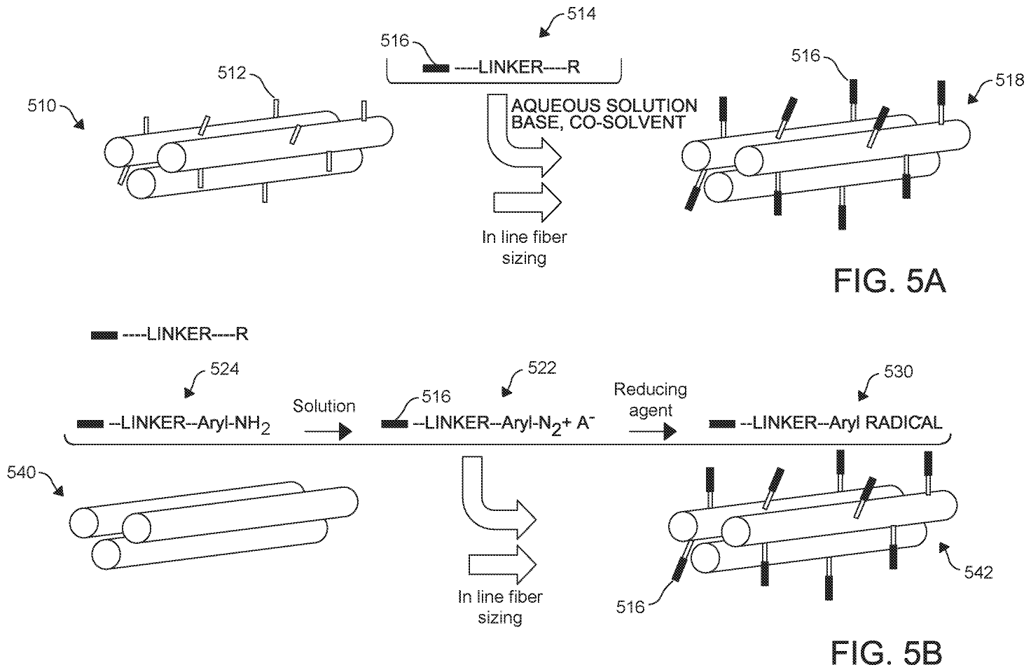

For a sized fiber, such as an epoxy-sized fiber, the modification or functionalization of the sized fiber may proceed as in FIG. 5A. In FIG. 5A, the sized fibers 510 may include pendant moieties at the fiber sizing 512. As an example, the sized fibers may comprise pendant epoxy moiety 512. The sized fibers 510 may be reacted in an aqueous solution in a base co-solvent with a molecule 514 having a pendant moiety 516 that may form a ternary complex within the CB[8]. The molecule 514 may be characterized by the formula R-linker-pendant moiety 516. The linker may comprise an aliphatic or aromatic organic substituent. In one example, the linker includes an ester. The pendant moiety 516, which may form a ternary complex with CB[8] with a high affinity, may comprise moieties as described above. R may be a nucleophilic reactive species toward epoxy, for example, since the fiber is epoxy-sized. The R nucleophilic reactive species may include, for example, amine —NH₂, hydroxide —OH, thiol —SH, or carboxylic —COOH. Thus, via a nucleophilic reaction, the pendant moiety 516 may be exchanged thereby modifying the sized fibers 510 to form functionalized sized fibers 518 that include pendant moieties 516 that may form a ternary complex within CB[8].

More specifically, epoxy-sized fibers may be functionalized in solution by means of by means of nucleophilic attack with a molecule containing a pendant moiety with a high affinity towards CB[8]. The molecule may include a nucleophilic reactive group R and a pendant moiety with a high affinity towards CB[8]. The nucleophilic reactive group R may include a primary amine, secondary amine, hydroxyl, carboxylate anion, thiol, thiolate, thiocyanate, isothiocyanate, alkoxide, hydrogen peroxide, azide, ammonia, nitrites, among others. The nucleophilic reactive group and the pendant moiety with high affinity to CB[8] may be linked by an organic linker. The pendant moiety with high affinity to CB[8] in the sized fibers may include methyl viologen or benzobis(imidazolium)salt. As provided above, other pendant moieties with high affinity to CB[8] that may be used in molecule include 2-napthol and phenol. In one example, the loading of the pendant moiety in the reinforcement fiber may be, from about 0.01 wt. % to about 0.6 wt. % , from about 0.05 wt. % to about 0.6 wt. %, from about 0.1 wt. % to about 0.3 wt. %, from about 0.15 wt. % to about 0.6 wt. %, or from about 0.1 wt. % to about 0.6 wt. % based on the total weight of the reinforcement fiber. The epoxy content of the epoxy-sized fibers may be from about 0.1 wt. % to about 0.6 wt. % based on the total weight of the epoxy-sized fibers. The co-solvent may include water, dichloromethane, chloroform, acetone, cyclohexane, hexane, or acetonitrile for example. A molar concentration of active molecule in solution may be within a range of 0.1 up to 1 M. The organic linker may include aliphatic or aromatic constituents.

In some cases, grafting rather than sizing may be required to introduce specific ligands or pendant moieties onto the fiber. The fiber may be functionalized in a solution by means of a radical attack with an activated molecule containing a pendant methyl viologen or benzobis(imidazolium) salt functionality by means of a chemical grafting method in solution. A common, versatile and fast grafting approach used is based on the diazonium salts intermediate approach. A suitable fiber may thus be modified by a method of a reactive radical intermediate species. One versatile and fast grafting technique for a material/surface (metal, glass, carbon fiber, nanotubes, etc.) includes the use of a reactive radical intermediate that is generated upon reduction of a diazonium salt derivative. Reduction may be achieved through addition of reducing agents (such as, for example, ascorbic acid, phosphorous acid (H₃PO₂) or iron (Fe)) or thermal, electro chemical, light sensitization, UV, electro, ultrasound, spontaneous and microwave exposure. The diazonium salts may be generated in situ or ex situ starting from their aniline analogues. In one specific example, a diazonium salt derivative containing a pendant methyl viologen ligand may be synthesized and used to graft fibers as shown in FIG. 5B. These ligands allow the formation of CB[8] ternary complexes during impregnation with specific the polymer emulsions as described above.

For an unsized fiber, the modification of the reinforcement fiber may proceed via generation of an in situ diazonium salt as shown in FIG. 5B. In FIG. 5B, the grafting method is based on reacting an activated molecule (where R is the aryl diazonium salt species, a precursor functionality for the production of the diazonium salt) which has been generated in situ or added as such. A diazonium salt derivative 522 comprising a pendant moiety 516 having a high affinity for CB[8] may be produced in solution from its aniline analogue 524. The solution may include, for example, 25% fluoroboric acid (HBF₄) and 1.1 equivalents sodium nitrite (NaNO₂). The diazonium salt derivative 522 may be reduced to provide an activated molecule (reactive aryl diazonium radical) 530 by the addition of a reducing agent. The reducing agent may include, for example, ascorbic acid, hypophosphorous acid (H₃PO₂), or iron (Fe). In further examples, the reducing agent may include a solution including components such as ascorbic acid, H₃PO₂, or Fe. Other reducing agents may include 0.5 molar (M) hydrochloric acid and 50% H₃PO₂ (50:50 v:v) or similar. Another suitable reducing agent includes a combination of HBF₄/50% H₃PO₂ (50:50 v:v). The resulting aryl diazonium radical 530 comprising the pendant moiety 516 may react with unsized fibers 540 via in line fiber sizing to form functionalized fibers 542.

To prepare the fiber-reinforced thermoplastic composite, the thermoplastic resin and surfactant may be combined in the presence of CB[8] to provide a CB[8]-based polymer emulsion. The CB[8]-based polymer emulsion may be combined with the functionalized fiber (having pendant moieties) as described above. By impregnating the functionalized fiber, displacing the surfactant molecule and removing water, a CB[8]-containing fiber-reinforced thermoplastic composite may be formed.

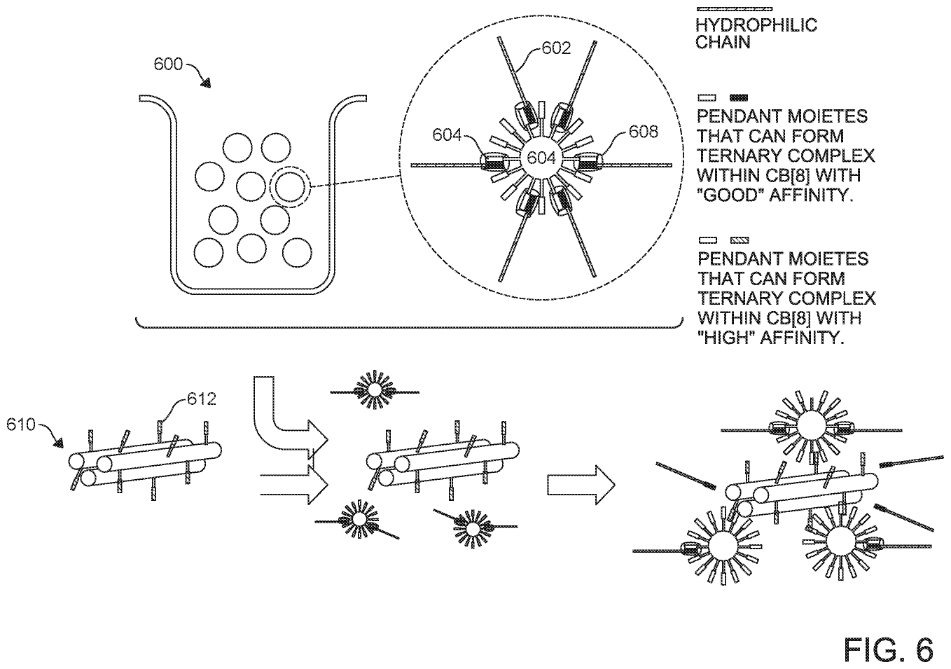

In one example, a thermoplastic resin including phenol, 2-naphthol moieties as pendant moieties or within the sidechain of the molecule may be bonded supramolecularly with reinforcement fibers that are grafted with methyl viologen or aryl-bis(imidazolium)salt functionalities toughened within a cucurbit[8]uril cavity. The resulting ternary complexes dissociate at elevated temperatures, facilitating the flowability and formability, and upon cooling the ternary complexes will be reinstated giving the composite enhanced mechanical performance and interlaminar shear strength. FIG. 6 presents a schematic diagram of the process for CB[8]-based polymer emulsion impregnation and composite production. The polymer emulsion 600 includes surfactant molecules (having hydrophilic chains 602) and polymer 604 having good affinity pendant moieties 606 which are pendant moieties that may form a ternary complex within CB[8] 608 with a good affinity. The polymer emulsion 600 is reacted with the functionalized fiber reinforcement 610 which has high affinity pendant moieties 612 which may form ternary complex within CB[8] 608 with a “high” (better) affinity. As shown, the functionalized fiber reinforcement 610 may displace the surfactant molecules 602 and form a ternary complex with CB[8]. The relative terms good and high may refer to the kinetics observed with respect to the formation of complexes and interactions among the pendant moieties and CB[8].

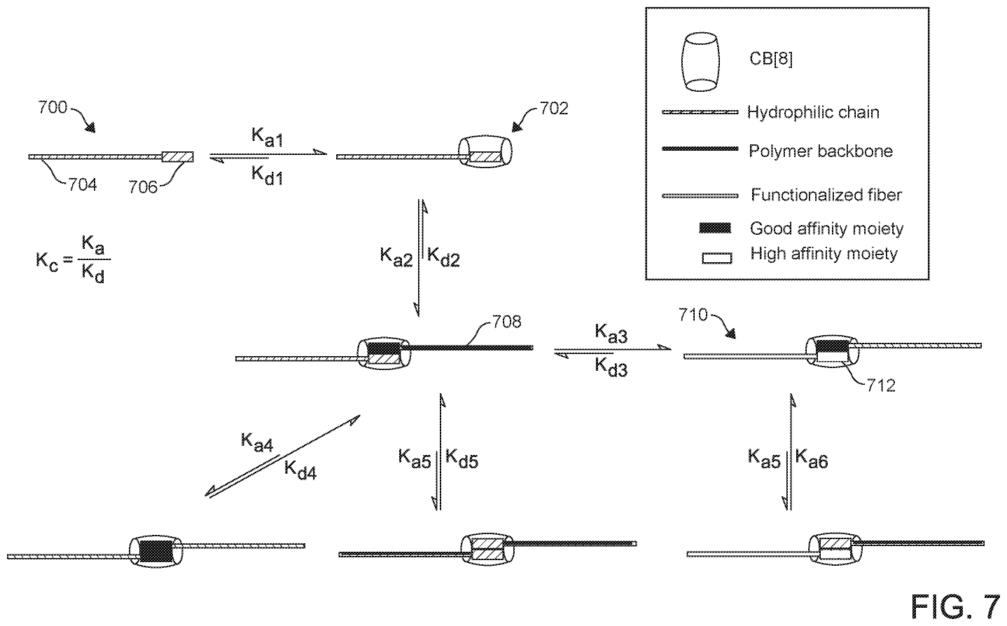

FIG. 7 summarizes the kinetic behavior that may affect the use of CB[8]-based polymer emulsions for impregnation and composite production. Association rate constant kₐ₁ for the formation of the binary complex provides the association rate of CB[8] 702 with the surfactant molecule 700 having a hydrophilic chain 704 and “good affinity” pendant moieties 706 (in that they show “good” affinity for CB[8] 702); kₐ₂ for the formation of the ternary complex shows the association of CB[8] 702 with a polymer backbone 708 having high affinity pendant moieties (moieties that have “high affinity” for CB[8] 702); kₐ₃ provides the reaction rate for the displacement of the surfactant molecule 700 in the CB[8] 702 ternary complex with the functionalized fiber 710 having high affinity pendant moieties 712 (in that the moieties have high affinity to CB[8] 702); kₐ₄, kₐ₅, kₐ₆ provide the association rates for the polymer backbone 704 and surfactant molecule displacement in the CB[8] complex. The equilibrium constant expression is denoted K_{C} and is equal to the ratio of kₐ to k_{d}. Dissociation rates of the foregoing are presented as k_{d1}, k_{d2}, k_{d3}, k_{d4}, k_{d5}, and kₐ₆. To achieve the CB[8]-based polymer emulsion for impregnation and composite production, the pendant moieties are selected in such a manner that K_{C3}>K_{C2} and K_{C1}>>K_{C4}>>>K_{C5}>>K_{C6}.

Various combinations of elements of this disclosure are encompassed by this disclosure, for example, combinations of elements from dependent claims that depend upon the same independent claim.

### Aspects of the Disclosure

In various aspects, the present disclosure pertains to and includes at least the following aspects.

Aspect 1A: A method of forming a composite, the method comprising: combining a thermoplastic polymer and a surfactant in the presence of a guest-host complexation agent to form a guest-host polymer emulsion; modifying a fiber reinforcement filler to form a modified fiber reinforcement; and combining the guest-host polymer emulsion with the modified fiber reinforcement to form a fiber-reinforced composite.

Aspect 1B: A method of forming a composite, the method consisting of: combining a thermoplastic polymer and a surfactant in the presence of a guest-host complexation agent to form a guest-host polymer emulsion; modifying a fiber reinforcement filler to form a modified fiber reinforcement; and combining the guest-host polymer emulsion with the modified fiber reinforcement to form a fiber-reinforced composite.

Aspect 1C: A method of forming a composite, the method consisting essentially of: combining a thermoplastic polymer and a surfactant in the presence of a guest-host complexation agent to form a guest-host polymer emulsion; modifying a fiber reinforcement filler to form a modified fiber reinforcement; and combining the guest-host polymer emulsion with the modified fiber reinforcement to form a fiber-reinforced composite.

Aspect 2: The method of any one of aspects 1A-1C, wherein the thermoplastic polymer comprises polypropylene (PP), polyamide 6 (PA6), polyamide 66 (PA66), polybutylene terephthalate (PBT), polycarbonate (PC), polyetherimide (PEI), and polyether ketone (PEEK), polyphenylene sulfide (PS), polyetherimide (PEI), N-phenyl phenolphthalein bisphenol polycarbonate (PPPB PC), or a combination thereof.

Aspect 3: The method of any one of aspects 1A-2, wherein the surfactant comprises a hydrophilic moiety, a pendant moiety exhibiting good affinity to the guest-host complexation agent, and an organic linker.

Aspect 4: The method of any one of aspects 1A-3, wherein the thermoplastic polymer comprises pendant moieties exhibiting high affinity to the guest-host complexation agent.

Aspect 5: The method of any one of aspects 1A-4, wherein the guest-host complexation agent comprises cucurbit[8]uril.

Aspect 6: The method of any one of aspects 1A-5, wherein the modified fiber reinforcement has a pendant moiety with high affinity towards the guest-host complexation agent.

Aspect 7: The method of aspect 6, wherein the pendant moiety with high affinity to guest-host complexation agent comprises a methyl viologen or benzobis(imidazolium) salt.

Aspect 8: The method of any one of aspects 1A-7, wherein the step of modifying the fiber reinforcement filler comprises reacting a nucleophilic reactive group with the fiber reinforcement filler and a pendant moiety with a high affinity towards the guest-host complexation agent.

Aspect 9: The method of any one of aspects 1A-8, where the step of combining the thermoplastic polymer and the surfactant in the presence of the guest-host complexation agent to form the guest-host polymer emulsion comprises high shear mixing.

Aspect 10: The method of any one of aspects 3-9, wherein the pendant moiety is present in the modified fiber reinforcement in an amount of about 0.1 wt. % to 0.6 wt. % based on the total weight of the fiber reinforcement.

Aspect 11: The method of any one of aspects 3-9, wherein the pendant moiety is present in the modified fiber reinforcement in an amount of about 0.15 wt. % to 0.6 wt. % based on the total weight of the fiber reinforcement.

Aspect 12: The method of any one of aspects 1A-11, wherein the modified fiber reinforcement is epoxy-sized with an epoxy loading content of about 0.1 wt. % to 0.6 wt. % based on the total weight of the modified fiber reinforcement.

Aspect 13: The method of any one of aspects 1A-11, wherein the modified fiber reinforcement is epoxy-sized with an epoxy loading content of about 0.2 wt. % to 0.6 wt. % based on the total weight of the modified fiber reinforcement.

Aspect 14: The method of any one of aspects 1A-11, wherein high affinity comprises an affinity for binding at a value of Kₐ of greater than10⁵ M⁻¹.

Aspect 15: The method of any one of aspects 1A-12, wherein good affinity comprises an affinity for binding at a value of Kₐ of between 10² M⁻¹ and 10⁵ M⁻¹.

Aspect 16A: A fiber-reinforced thermoplastic composite formed by a process comprising: combining a thermoplastic polymer and a surfactant in the presence of a cucurbit[8]uril (CB[8]) to provide a CB[8]-based polymer emulsion; and impregnating functionalized reinforcement fibers with the CB[8]-based polymer emulsion to displace surfactant to form a fiber-reinforced thermoplastic composite.

Aspect 16B: A fiber-reinforced thermoplastic composite formed by a process consisting essentially of: combining a thermoplastic polymer and a surfactant in the presence of a cucurbit[8]uril (CB[8]) to provide a CB[8]-based polymer emulsion; and impregnating functionalized reinforcement fibers with the CB[8]-based polymer emulsion to displace surfactant to form a fiber-reinforced thermoplastic composite.

Aspect 16C: A fiber-reinforced thermoplastic composite formed by a process consisting of: combining a thermoplastic polymer and a surfactant in the presence of a cucurbit[8]uril (CB[8]) to provide a CB[8]-based polymer emulsion; and impregnating functionalized reinforcement fibers with the CB[8]-based polymer emulsion to displace surfactant to form a fiber-reinforced thermoplastic composite.

Aspect 17: The fiber-reinforced thermoplastic composite of any one of aspects 16A-16C, wherein the thermoplastic polymer comprises pendant moieties having an affinity for cucurbit[8]uril.

Aspect 18: The fiber-reinforced thermoplastic composite of any one of aspects 16A-17, wherein the surfactant comprises an organic linker, a hydrophilic moiety, and a pendant moiety having an affinity for CB[8].

Aspect 19: The fiber-reinforced thermoplastic composite of any one of aspects 16A-18, wherein the functionalized reinforcement fibers comprise epoxy-sized fibers.

Aspect 20: The fiber-reinforced thermoplastic composite of any one of aspects 16A-19, wherein the functionalized reinforcement fibers comprise grafted fibers.

Aspect 21: The fiber-reinforced thermoplastic composite of any one of aspects 16A-20, wherein the functionalized reinforcement fibers comprise pendent moieties with a high affinity to CB[8].

Aspect 22: The fiber-reinforced thermoplastic composite of any one of aspects 16A-21, wherein the functionalized reinforcement fibers comprise pendant moieties comprising methyl viologen, benzobis(imidazolium salt), or 2-napthol phenol.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

Several processes and methods may be used in the CB[8]-based polymer emulsion formation and characterization according to aspects of the present disclosure. A high speed homogenizer was used to emulsify an organic polymer solution with an aqueous surfactant solution under high shear. Homogenizer Model L5M, motor 0.33hp (250 W) 110 volt single phase, 50/60 Hz, offers a maximum speed of 10,000 rpm. Shear was controlled by the homogenization speed and particle size was controlled by the screen heads. Within this homogenizer three types of screens were used to get different particle size. The size of the polymer particles in final dispersion was controlled by adjusting the amount of surfactant; however, processing parameters can also play a role in controlling particle size. Keeping the amount of surfactant constant by changing the screen heads can provide different particle size distribution (PSD).

A high pressure hydrothermal approach in Parr reactor Series 4560 Benchtop 300 ml Mini Parr Reactor was used for the emulsification of crystalline PP, designed with a flat, polytetrafluoroethylene (PTFE) gasket for operating temperatures up to 350° C. maximum. Standard mini reactors can be converted to high temperature reactors (500° C. max temperature and 2000 psi maximum allowable working pressure) by changing the head assembly (contains cone connections, high temperature valves, and a graphoil gasket) and replacing the heater with a ceramic fiber heater and the split ring.

Characterization of the emulsion or composite may be performed according to the methods described below. pH measurements were obtained using a High-precision 780 pH meter from Metrohm equipped with the glass pH electrode and temperature sensor. PSD analysis was performed on a Malvern Nanosizer ZS. The samples were analyzed in a disposable cuvette with 5% polymer emulsion, further diluting by 50% with DI water, at 20° C. The angle of detection of the scattered light was 173°, as determined by back-scatter. The Nanosizer ZS used a 4 milliWatt (mW) He—Ne laser, with an operating wavelength (λ0) of 633 nm.

Dynamic light scattering (DLS) probes the Brownian motion of the particles in a liquid suspension under conditions of constant temperature. The Stokes-Einstein relation, represented by Equation I, relates the hydrodynamic diameter and translational diffusion coefficient.

$$D = \frac{kT}{6 πη A} \qquad ( I )$$

where, D is the translational diffusion coefficient, k is the Boltzmann constant, T is temperature in degree Celsius (° C.), and η is the liquid viscosity.

For the DLS study, a particle size distribution for all polymer emulsion samples was derived solely from the intensity particle size distribution.

Thermogravimetric analysis (TGA) of dried thermoplastic emulsion powders was performed on a TA Instruments TGA Q5000 under the nitrogen atmosphere at a heating rate of 20° C. per minute in the range of room temperature (RT) to 800° C.

Differential Scanning calorimetry (DSC) was performed to determine the melting point and crystallinity temperatures of dried polymer emulsion powders. A TA Instruments Q1000 was used under a nitrogen atmosphere at a heating rate of 10° C. per minute from −70 to 350° C. Transmission Electron Microscopy (TEM) was also performed. A drop of the thermoplastic resin emulsion (1% in water) was placed on a Formvar copper grid and the excess solvent was drained. The sample was stained in ruthenium tetroxide vapors for 5 mins. The images were recorded using Tecnai T12 TEM at an accelerating voltage of 120 kiloelectron volt (keV).

Viscosity of the developed emulsions and commercial benchmark sizings were measured by an ARES G2 Rheometer equipped with a bob-cup geometry, which provided comparable values in all the cases (0.98-1.11 cP at 25° C.).

Isothermal titration experiments were carried out on a MicroCal VP-ITC at 25° C. The ternary complex formation binding equilibria were studied using a cellular CB[8]⋅dicationic auxiliary guests (AG) concentration of typically of 0.1 milliMolar (mM), to which the 10× higher concentrated analyte solution was titrated. The titrations were carried out in 10 mM sodium phosphate buffer (pH 7); essentially identical Kₐ₂ values were obtained in neat deionized water for non-charged analytes. Kₐ₂ is the second binding affinity of the generated ternary complex. Typically 20-30 consecutive injections of 10 microliters (μL) each were used. All solutions were degassed prior to titration. Heats of dilution were determined by titration of the guest/analyte solution into water. The first data point was removed from the data set prior to curve fitting. The data was analyzed with Origin 7.0 software with the one-set-of-sites model. The knowledge of the complex stability constant (Kₐ) and molar reaction enthalpy (ΔH°) enabled the calculation of the standard free energy (ΔG°) and entropy changes (ΔS°) according to ΔG°=−RT In Kₐ=ΔH°−TΔS°. For each system, 1-2 repetition experiments were conducted in order to estimate the error in the thermodynamic values.

Formed composites exhibit the properties described herein.

### Definitions

The above detailed description includes references to the accompanying drawings, which form a part of the detailed description. The drawings show, by way of illustration, examples of how the disclosure may be practiced. Such examples may include elements in addition to those shown or described or may include only the elements shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, to include one or more than one, independent of any other instances or usages of “at least one” or “one or more.” The term “or” is used to refer to a nonexclusive or. The terms “including” and “in which” are used as the plain-English equivalents of the respective terms “comprising” and “wherein.” Also, in the following claims, the term “comprising” is open-ended. Moreover, in the following claims, the terms “first,” “second,” and “third,” etc. are used merely as labels, and are not intended to impose numerical requirements on their objects. The Abstract is provided to allow the reader to quickly ascertain the nature of the technical disclosure and is not to be used to interpret or limit the claims. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed aspect, the terms “substantially” and “about” may be substituted within “within [a percentage] of” what is specified, where the percentage includes 0.1, 1, 5, and 10 percent.

It is to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural equivalents unless the context clearly dictates otherwise. Thus, for example, reference to “a polycarbonate polymer” includes mixtures of two or more polycarbonate polymers.

As used herein, the term “combination” is inclusive of blends, mixtures, alloys, reaction products, and the like.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±5% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, “free of,” or “substantially free of, solvents or chemical solvents, or additives, as used herein may indicate that solvents and/or additives have not been added to the components. Or, “substantially free of” may refer to less than 0.01 wt. %, or less than about 0.01 wt. %. In yet another aspect, substantially free of can be less than 100 parts per million (ppm), or less than about 100 ppm. Substantially free can refer to an amount, if present at all, below a detectable level.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

As used herein, basalt may refer to a material including plagioclase, pyroxene, and olivine minerals.

As used herein, aramid or aramid fibers may refer to synthetic fibers including aromatic polyamide.

As used herein, “hydrophobic” or “hydrophobicity” refers to the property of a surface or substance or moiety to repel water. A hydrophobic moiety may refer to a water insoluble moiety that is attached to a polymer side chain, for example, and interacts with another hydrophobic moiety

As used herein, “hydrophilic” or “hydrophilicity” refers to the property of a surface or substance or moiety to attract water. A hydrophilic moiety may refer to a water soluble group.

As used herein, “aryl” refers to a carbocyclic (all carbon) monocyclic or multi-cyclic aromatic ring system that has a fully delocalized pi-electron system. Examples of aryl groups include, but are not limited to, benzene, naphthalene and azulene. As used herein, “heteroaryl” refers to a monocyclic or multi-cyclic aromatic ring system (a ring system with fully delocalized pi-electron system) that contain(s) one or more heteroatoms, that is, an element other than carbon, including but not limited to, nitrogen, oxygen and sulfur.

As used herein, “alkyl” refers to a straight or branched hydrocarbon chain fully saturated (no double or triple bonds) hydrocarbon group. “C1-4 alkyl” indicates that there are one to four carbon atoms in the alkyl chain, i.e., the alkyl chain is selected from the group consisting of methyl, ethyl, propyl, iso-propyl, butyl, iso-butyl, sec-butyl, and tert-butyl. Typical alkyl groups include, but are not limited to, methyl, ethyl, propyl, isopropyl, butyl, isobutyl, tertiary butyl, and the like. As used herein, “alkenyl” refers to an alkyl group that contains in the straight or branched hydrocarbon chain bearing one or more double bonds. As used herein, “alkynyl” refers to an alkyl group that contains in the straight or branched hydrocarbon chain with one or more triple bonds.

As used herein, “cation” refers to a counter ion of the anionic group, e.g., carboxyl group on the side chain of the polymer backbone. Examples of cation may include, but are not limited to, hydrogen, ammonium, alkali metal, and alkali earth metal. In one aspect, cation is sodium.

As used herein, “prepreg” refers to “pre-impregnated” composite; a reinforcing fabric or material which has been pre-implanted within a resin system.

Kₐ is the binding constant for chemical reactions involving weak acids in aqueous solution.

K_{c} is the equilibrium constant for chemical reactions involving weak acids in aqueous solution.

The abbreviation “nm” stands for nanometer(s).

The abbreviation “μm” stands for micrometer(s).

As used herein the terms “weight percent,” “wt. %,” and “wt. %” of a component, which can be used interchangeably, unless specifically stated to the contrary, are based on the total weight of the formulation or composition in which the component is included. For example if a particular element or component in a composition or article is said to have 8% by weight, it is understood that this percentage is relative to a total compositional percentage of 100% by weight.

Unless otherwise stated to the contrary herein, all test standards are the most recent standard in effect at the time of filing this application.

1. A method of forming a composite, the method comprising:
combining a thermoplastic polymer and a surfactant in the presence of a guest-host complexation agent to form a guest-host polymer emulsion;
modifying a fiber reinforcement filler to form a modified fiber reinforcement; and
combining the guest-host polymer emulsion with the modified fiber reinforcement to form a fiber-reinforced composite.

2. The method of claim 1, wherein the thermoplastic polymer comprises polypropylene (PP), polyamide 6 (PA6), polyamide 66 (PA66), polybutylene terephthalate (PBT), polycarbonate (PC), polyetherimide (PEI), and polyether ketone (PEEK), polyphenylene sulfide (PS), polyetherimide (PEI), N-phenyl phenolphthalein bisphenol polycarbonate (PPPB PC), or a combination thereof.

3. The method of claim 1, wherein the surfactant comprises a hydrophilic moiety, a pendant moiety exhibiting good affinity to the guest-host complexation agent, and an organic linker.

4. The method of claim 1, wherein the thermoplastic polymer comprises pendant moieties exhibiting high affinity to the guest-host complexation agent.

5. The method of claim 1, wherein the guest-host complexation agent comprises cucurbit[8]uril.

6. The method of claim 1, wherein the modified fiber reinforcement has a pendant moiety with high affinity towards the guest-host complexation agent.

7. The method of claim 6, wherein the pendant moiety with high affinity to guest-host complexation agent comprises a methyl viologen or benzobis(imidazolium) salt.

8. The method of claim 1, wherein the step of modifying the fiber reinforcement filler comprises reacting a nucleophilic reactive group with the fiber reinforcement filler and a pendant moiety with a high affinity towards the guest-host complexation agent.

9. The method of claim 1, where the step of combining the thermoplastic polymer and the surfactant in the presence of the guest-host complexation agent to form the guest-host polymer emulsion comprises high shear mixing.

10. The method of claim 3, wherein the pendant moiety is present in the modified fiber reinforcement in an amount of about 0.1 wt. % to 0.6 wt. % based on the total weight of the fiber reinforcement.

11. The method of claim 1, wherein the modified fiber reinforcement is epoxy-sized with an epoxy loading content of about 0.1 wt. % to 0.6 wt. % based on the total weight of the modified fiber reinforcement.

12. The method of claim 1, wherein high affinity comprises an affinity for binding at a value of Kₐ of greater than10⁵ M⁻¹.

13. The method of claim 1, wherein good affinity comprises an affinity for binding at a value of Kₐ of between 10² M⁻¹ and 10⁵ M⁻¹.

14. A fiber-reinforced thermoplastic composite formed by a process comprising:
combining a thermoplastic polymer and a surfactant in the presence of a cucurbit[8]uril (CB[8]) to provide a CB[8]-based polymer emulsion; and
impregnating functionalized reinforcement fibers with the CB[8]-based polymer emulsion to displace the surfactant to form a fiber-reinforced thermoplastic composite.

15. The fiber-reinforced thermoplastic composite of claim 14, wherein the thermoplastic polymer comprises pendant moieties having an affinity for cucurbit[8]uril.

16. The fiber-reinforced thermoplastic composite of claim 14, wherein the surfactant comprises an organic linker, a hydrophilic moiety, and a pendant moiety having an affinity for CB[8].

17. The fiber-reinforced thermoplastic composite of claim 14, wherein the functionalized reinforcement fibers comprise epoxy-sized fibers.

18. The fiber-reinforced thermoplastic composite of claim 14, wherein the functionalized reinforcement fibers comprise grafted fibers.

19. The fiber-reinforced thermoplastic composite of claim 14, wherein the functionalized reinforcement fibers comprise pendent moieties with a high affinity to CB[8].

20. The fiber-reinforced thermoplastic composite of claim 14, wherein the functionalized reinforcement fibers comprise pendant moieties comprising methyl viologen, benzobis(imidazolium salt), or 2-napthol phenol.
